(19) United States
(12) Patent Application Publication
(10) Pub. No.: US 2007/0186956 A1
(43) Pub. Date: Aug. 16, 2007

(54) APPARATUS AND METHOD FOR CLEANING THE INTERIOR OF TRANSPORT TRUCK TRAILERS

(76) Inventor: David Charles SCHLUETER, Waterloo (CA)

Correspondence Address: BERESKIN AND PARR, 40 KING STREET WEST, BOX 401, TORONTO, ON, M5H 3Y2, US

(21) Appl. No.: 11/674,423

(22) Filed: Feb. 13, 2007

(30) Foreign Application Priority Data
Feb. 14, 2006 (CA) 2536223

(51) Int. Cl. B08B 9/04

(52) U.S. Cl. 134/8; 134/123; 134/168 R

(57) ABSTRACT

The invention is directed toward an apparatus and method for cleaning trailers of transport trucks, which makes use of an air supply of an air brake system within the transport truck. A portable cleaning apparatus is connected to the air brake system to allow a user to clean soiled surfaces in the interior of the trailer. One embodiment of the cleaning apparatus includes an air supply hose, a wand, and a liquid delivery system which may include a portable container containing liquid and a mixer for combining the air and liquid. As air flows through the compressed air supply line and out of the wand, the airflow siphons liquid from the portable container at the mixer.

The invention relates generally to systems for cleaning the interior of trailers for transport trucks, and in particular, to apparatus and methods for cleaning the floors of refrigerated trailers used to transport temperature sensitive products.

### BACKGROUND OF THE INVENTION

Transport trucks are used to transport a wide variety of goods. Meat products and other perishable food products are typically transported in reefer trailers, i.e. refrigerated trailers having a corrugated floor made up of a series of upper and lower channels that extend the length of the trailer.

The interior surfaces of transport truck trailers become dirty over time and require cleaning. The corrugated floors of reefer trailers pose a particular cleaning challenge, as it is difficult to remove dirt, stains and other debris from the upper and lower channels of these floors.

There are a few known methods for cleaning the floors of transport truck trailers. A push broom can be used to sweep the floors of trailers, but manually sweeping using push brooms can be time consuming and laborious. Also, push brooms are not very effective at removing fine debris in the corners of the trailer, or dirt, muck and stains in the lower channels of reefer trailers.

A leaf blower, typically a gas powered leaf blower, can be used to clean out trailers. This method is generally faster and less labor intensive than the push broom method. However, gas and oil fumes from the leaf blower may fill the trailer, making a hazardous work environment for the operator, and unacceptable if food items are to be loaded into the trailer soon after cleaning. Furthermore, even leaf blowers that provide a strong airflow cannot remove muck and stains. Some drivers clean their reefer trailers at specialized truck trailer cleaning stations having pressure washing equipment. This method is generally less labor intensive and more effective than the aforementioned prior art methods. However, trailer cleaning stations are located sporadically throughout the country, which means that drivers usually have to deviate from their intended course to reach one of these stations. When drivers arrive at the cleaning station, they often have to wait in a lineup of trucks before they can clean the trailer. After pressure washing, it is generally necessary to allow the interior of the trailer to dry, which typically takes a couple of hours, during which time the refrigeration unit should be running to circulate air. All of this activity wastes time and fuel.

There is accordingly a need for a truck trailer cleaning system that overcomes the problems associated with known methods. In particular, there is a need for trailer cleaning apparatus adapted particularly for cleaning reefer trailers, which is easy to use, low in cost and relatively time efficient.

### SUMMARY OF THE INVENTION

The present invention is directed to an apparatus for cleaning an interior portion of a trailer coupled to a transport truck having an engine and a truck air brake system comprising an air compressor powered by the engine, an air brake line connected to the air compressor, and a trailer coupler for coupling the air brake line to a trailer brake system associated with the trailer.

One aspect of the present invention is an dry/wet cleaning apparatus comprising a compressed air supply line having a brake line coupler shaped for releasably coupling to the trailer coupler so as to receive a flow of compressed air from the air compressor, a wand releasably couplable to the compressed air supply line, the wand comprising a tubular body having a flow passage therethrough, a hose coupler extending from a first end of the tubular body for coupling to the air supply hose, a nozzle extending from a second end of the tubular body, a handle portion spaced from the second end, and a control for controlling the flow of compressed air to the nozzle, and a liquid delivery system for delivering liquid to the air flow passage of the wand.

Another aspect of the present invention is an apparatus for cleaning an interior portion of a trailer coupled to a transport truck, comprising an air supply hose having a first end and a second end, a brake line coupler extending from the first end shaped for releasably coupling to the trailer coupler so as to receive a flow of compressed air from the air compressor, and a wand coupler extending from the second end, and a wand releasably couplable to the air supply hose. The wand comprises a tubular body having a flow passage and a free end, a nozzle attached to the free end, and a handle portion spaced from the free end, the handle portion including a control for controlling the flow of compressed air to the nozzle. The air supply hose and the wand coupler are sized to fit through an aperture in a forward portion of the trailer.

The air supply hose may comprise a short hose and a long hose releasably coupled thereto, the short hose being sized to extend from the trailer coupler through an aperture in the trailer to a selected point inside a front portion of the interior of the trailer, the long hose being sized to extend from the selected point through the interior of the trailer. The liquid delivery system may comprise a portable container for holding a supply of liquid, a mixer for mixing the liquid into the flow of compressed air, and a liquid supply line extending from the container to the mixer. The tubular body of the wand may comprise a first tubular body portion and a second tubular body portion, the second tubular body portion being releasably couplable to the first tubular body portion.

The present invention is also directed to a method for cleaning an interior surface of a trailer coupled to a transport truck. The method comprises the steps of decoupling a trailer coupler of an air brake line from the trailer air brake system, coupling a portable air supply hose to the air brake line by coupling to a brake coupler extending from a first end of the air supply hose to the trailer coupler, threading the air supply hose through an aperture in a forward portion of the trailer, connecting a wand to the air supply hose, the wand having a nozzle at a free end and a control for controlling the flow of compressed air through the nozzle, and using the wand and control to apply a controlled flow of compressed air from the air compressor to the interior surfaces of the trailer to clean the surfaces.

The method may further comprise the steps of decoupling the brake line coupler from the trailer coupler, and recoupling the trailer coupler to the trailer air brake system.

### BRIEF DESCRIPTION OF THE DRAWINGS

The invention will now be described by way of example only, with reference to the following drawings, in which:

FIG. 1 is a perspective view of a transport truck and a cleaning apparatus connected to an air brake system of the transport truck;

FIG. 2 is a perspective view of the cleaning apparatus according to an embodiment of the present invention;

FIG. 3 is a cross-sectional view of a handle for the cleaning apparatus along the section line shown in FIG. 2;

FIG. 4 is a perspective view of a cleaning apparatus according to an embodiment of the present invention;

FIG. 5 is a schematic diagram of a cleaning apparatus connected to an air brake system of a transport truck in accordance with an embodiment of the present invention; and

FIG. 6 is a flow chart depicting a method for cleaning a transport truck trailer according to an embodiment of the present invention;

FIG. 7 is a perspective view of a portion of the subject cleaning apparatus being used to clean a floor of a reefer trailer.

### DETAILED DESCRIPTION OF THE INVENTION

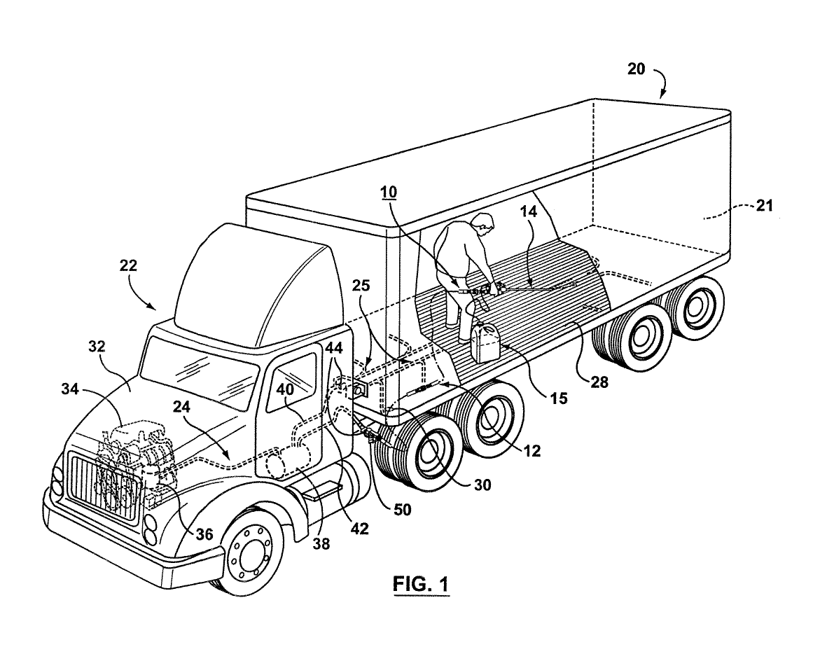

Referring to FIG. 1, illustrated therein is a portable “wet/dry” cleaning apparatus 10 made in accordance with a first embodiment of the present invention, for cleaning the interior portion of a trailer 20 coupled to a transport truck 22 having a truck air brake system 24. As shown, trailer 20 is a refrigerated or “reefer” trailer having an interior 21 that includes floor 28 having a drainage aperture 30 in at least one corner thereof. Floor 28 is a corrugated floor comprising a series of upper and lower channels that extend the length of trailer 20. Truck air brake system 24 includes air compressor 36 powered by engine 34 in engine compartment 32 to generate high-pressure air, air tank 38 coupled to air compressor 36 to provide a surplus of high-pressure air during heavy braking, and trailer control line 40 and trailer supply line 42 having trailer couplers 44 that are releasably coupled to trailer air brake system 25. Trailer couplers 44 are typically quick release couplers know as gladhand couplers. Trailer control line 40 is conventionally colored blue and trailer supply line 42 is conventionally colored red. Trailer control line 40 provides a flow of compressed air from air tank 38 that activates trailer air brake system 25 when the driver of transport truck 22 depresses the brake pedal or a hand brake. Trailer supply line 42 provides compressed air to an air reservoir within trailer air brake system 25 that provides for emergency braking in the event of an air brake system malfunction.

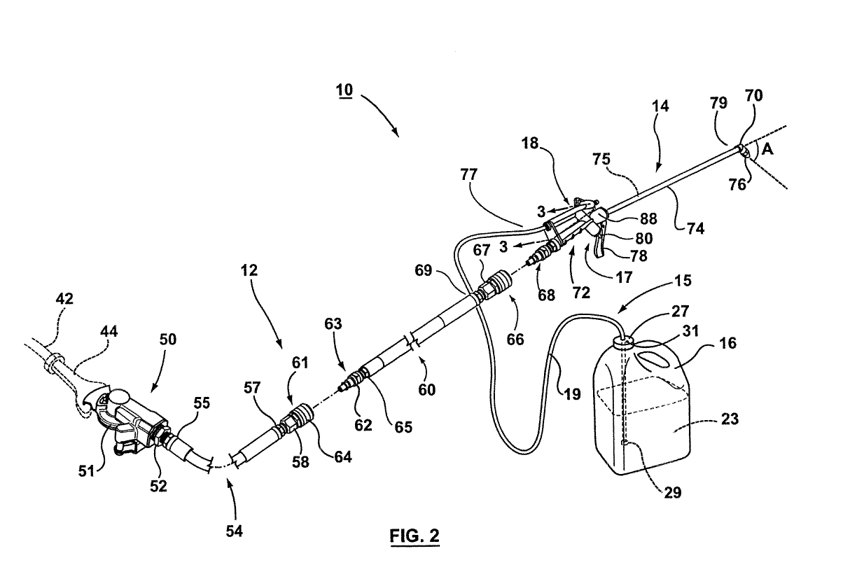

Referring now to FIG. 2, cleaning apparatus 10 comprises a portable air supply hose 12, a wand 14 releasably coupled to air supply hose 12, and a liquid delivery system 15 for delivering cleaning liquid to wand 14. Air supply hose 12 includes a brake line coupler 50 extending from one end shaped to releasably couple with trailer coupler 44 of trailer supply line 42. Wand 14 comprises a tubular body portion 74 having a flow passage 75 extending therethrough, a hose coupler 68 extending from first end 77, and a nozzle 76 extending from second end 79. Wand 14 also includes handle portion 72 spaced from second end 79, which includes an air flow control 17 for controlling the flow of compressed air to nozzle 76. Air travels through compressed air supply hose 12 to wand 14 where mixer 18 when activated by air control 17 draws in and mixes liquid with the air, and the mixture of air and liquid is then sprayed out of nozzle 76.

Compressed air supply hose 12 is preferably a two-piece hose comprising a short air hose 54 and a long air hose 60 releasably coupled thereto. Short air hose 54 comprises a brake line coupler 50 extending from a first end 55 and a long hose coupler 61 extending from a second end 57. Brake line coupler 50 may comprise a gladhand coupler 51 shaped to mate with gladhand trailer coupler 44, and an air line adapter 52 that converts the air brake line port of gladhand coupler 51 to a conventional pneumatic hose fitting. Long hose coupler 61 comprises a first female fitting 58 having a sliding collar 64 that acts as a retaining mechanism. First female fitting 58 is preferably a quick connect fitting having a check valve that prevents air loss when fitting 58 is left unconnected. Long hose coupler 61 is sized to fit through aperture 30, and is preferably about one inch wide.

Short hose 54 is adapted to be threaded up into trailer 20 through drainage aperture 30 and may be sized so as to extend from trailer coupler 44 through drainage aperture 30 to a point inside a forward portion of interior 21 of trailer 20 (see FIG. 1). Short hose 54 is preferably at least 5 feet long. If there are no drainage apertures in trailer 20, any aperture entering trailer 20 can be used, or a hole can be drilled through trailer 20 at a convenient location, such as the front, left corner, and the hole could be covered by a spring loaded metal cover.

Long air hose 60 comprises short hose coupler 63 extending from one end 65 shaped to mate with long hose coupler 61, and wand coupler 66 extending from opposing end 69. Short hose coupler 63 comprises a first male fitting 62 shaped to be releasably coupled to first female fitting 58 of long hose coupler 61. First male fitting 62 may be inserted within first female fitting 58 to create a fluid connection between short hose 54 and long hose 60. Connection of first male fitting 62 to first female fitting 58 opens the check valve in first female fitting 58 to create an airflow passage. First male fitting 62 includes a series of o-rings and flanges that are shaped to seal and lock with sliding collar 64 of first female fitting 58, so as to prevent hoses 54, 60 from being inadvertently decoupled during use. The details of these fittings are well known to someone skilled in the art. In some embodiments, the two fittings may be reversed so that the first male fitting 62 is on short hose 54 and the first female fitting 58 is on long hose 60. Other suitable types of connectors may alternatively be used for connecting hoses 54, 60.

Long air hose 60 may be sized to extend the length of floor 28 of trailer 20. Long hose 60 is preferably at least about 50 feet in length so that cleaning apparatus 10 can be used within a 48 or 53 foot long trailer. In some instances, trailers will be of different lengths and a longer hose may be needed. With the fittings as described, additional intermediate hoses (not shown) between first female fitting 58 and first male fitting 62 may be included to lengthen the hose as necessary.

Wand coupler 66 of long hose 60 comprises a second female fitting 67 that connects to hose coupler 68 extending from wand 14. Second female fitting 69 and hose coupler 68 are generally the same style fittings as the first female fitting 58 and first male fitting 62. Coupling wand coupler 66 to hose coupler 68 creates a fluid connection between long hose 60 and wand 14. When all parts of cleaning apparatus 10 are connected there should be a hollow air passage extending from air compressor 36 to wand 14, which allows a flow of air generated at air compressor 36 to reach nozzle 76 of wand 14 with no leakage.

Wand 14 comprises a tubular body 74 having an interior flow passage 75 extending between first end 77 and second end 79 that fluidly connects hose coupler 68 to nozzle 76 extending from second end 79. Flow control 17 allows a user to control the amount of air that comes out of nozzle 76, and comprises a handle lever 78 pivotally connected to handle body 88, which sits loosely on a poppet 80. Compressing handle lever 78 against handle body 88 depresses poppet 80 to allow a flow of air to proceed through wand 14 and exit out of nozzle 76. The degree of compression between handle lever 78 and handle body 88 controls how much airflow exits out of nozzle 76.

Nozzle 76 is preferably obliquely connected to tubular body 74 at an angle A. The angle is optional, but providing it allows easier cleaning as will be described later within the application. Preferably, angle A is roughly 30° but nozzle 76 could extend at other angles including a right angle.

Liquid delivery system 15 comprises a portable container 16 for containing a supply of cleaning liquid 23, a mixer 18 for mixing liquid 23 into the flow of compressed air through flow passage 75, and a liquid supply line 19 extending from container 16 to mixer 18. Container 16 includes a cap 27 with an aperture sized to receive supply line 19. Supply line 19 includes an intake 29 located within the interior of container 16 near the bottom thereof. Cleaning liquid 23 is preferably a liquid for diluting, emulsifying or decomposing grime on surfaces. For instance, liquid 23 could comprise a combination of soapy water and diluted bleach for cleaning blood stains or sappy substances deposited from food products. Preferably, portable container 16 has a vent hole 31 that allows the pressure within portable container 16 to equalize with the atmospheric pressure.

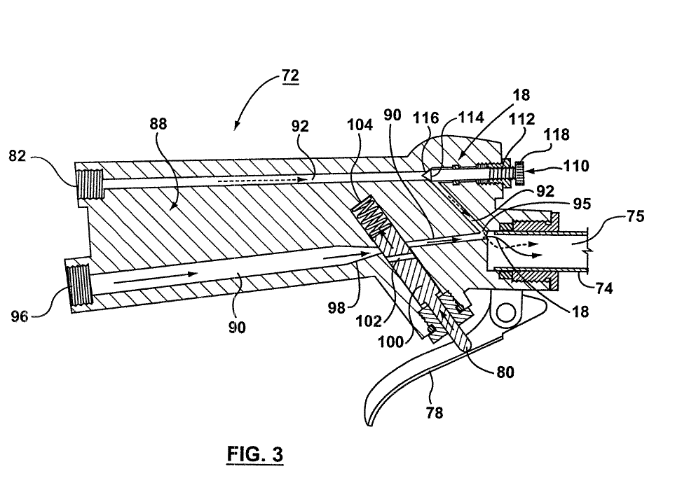

Referring now to FIG. 3, handle body 88 of handle portion 72 comprises an airflow passage 90 having a threaded connector at inlet 96 for receiving hose coupler 68. Located about midway through airflow passage 90 is a taper 98 that reduces the airflow cross-section. Due to mass flow continuity laws, the airflow speeds up through taper 98, which also reduces the air pressure according to Bernoulli's principle. A reduction in pressure helps to draw liquid into the airflow as will be discussed below. At the end of taper 98, a needle valve 100 controls the airflow via a connection with poppet 80. As previously noted, handle lever 78 shifts poppet 80 to move needle valve 100 between an open and closed position. In the open position, an aperture 102 resides at least partially in line with airflow passage 90 at the end of taper 98. When partially aligned, air can pass through needle valve 100 to mixer 18. In the closed position, needle valve 100 blocks and substantially seals off airflow passage 90 from mixer 18 such that aperture 102 is fluidly disconnected from airflow passage 90. A spring 104 biases needle valve 100 to the closed position. Closing handle lever 78 applies a force on poppet 80 to compress spring 104 at varying degrees, which allows a proportional amount of airflow to exit handle portion 72.

Mixer 18 of liquid delivery system 15 comprises liquid passage 92 in handle body 88 having a threaded connector at inlet 82, and mixing chamber 95. Liquid passage 92 connects with airflow passage 90 at mixing chamber 95, and the mixture of liquid and air flows out into flow passage 75 of wand 14. Within mixing chamber 95, the airflow should be at a suitably low pressure to siphon liquid into the air stream by a venturi effect. As shown, airflow passage 90 is substantially narrower at mixer 18 than at inlet 96 which reduces the air pressure as previous discussed. The reduction in cross-section should be sufficient to cause a pressure drop substantially below atmospheric pressure such that liquid may be drawn in from portable container against viscous and elevational effects.

Mixer 18 may include a thumbscrew valve 110 in liquid flow passage 92 to control the amount of liquid drawn into the air stream, up to a maximum set by the venturi effect caused by reducing the airflow passage cross-section. Thumbscrew valve 110 comprises a threaded end 112 that is received within handle body 88 and a conical end 114 that forms a gap with a flange 116 to restrict the amount of liquid drawn into the airflow. A knurled head 118 on thumbscrew valve 110 allows a user to screw valve 110 in and out to adjust the gap size between conical end 114 and flange 116. Generally, a larger gap size increases liquid flow and a smaller gap size reduces liquid flow.

Around both needle valve 100 and thumbscrew valve 110 are a series of bushings and seals that prevent a leakage of air or liquid from the valves. Various forms of seals may be used to achieve similar effects as known in the art. Furthermore, different types of valves may be used anywhere on cleaning apparatus 10, so long as there is a way of controlling the fluid flow through wand 14.

The handle portion 72 detailed in FIG. 3 is one of many possible constructions for achieving the controlling and mixing effects described. As shown, mixer 18 is a relatively simple construction having a mixing chamber 95 for drawing liquid into the airflow. Alternatively, mixer 18 may comprise other constructions for drawing liquid from a higher energy potential source to a lower energy potential airflow. Furthermore, in additional embodiments, mixer 18 may be located anywhere between truck air brake system 24 and nozzle 76.

In an alternative embodiment of the present invention, wand 14 could comprise two concentric tubes (not shown) in place of tubular body 74. In this embodiment, the mixer should exit into an annular flow passage between an inner tube and an outer tube. Thus, the mixture of air and liquid travels from handle portion 72 to nozzle 76 along the annular flow passage. The purpose of such an annular flow passage is to increase the mixing between the air and liquid such that a spray of greater homogeneity is achieved.

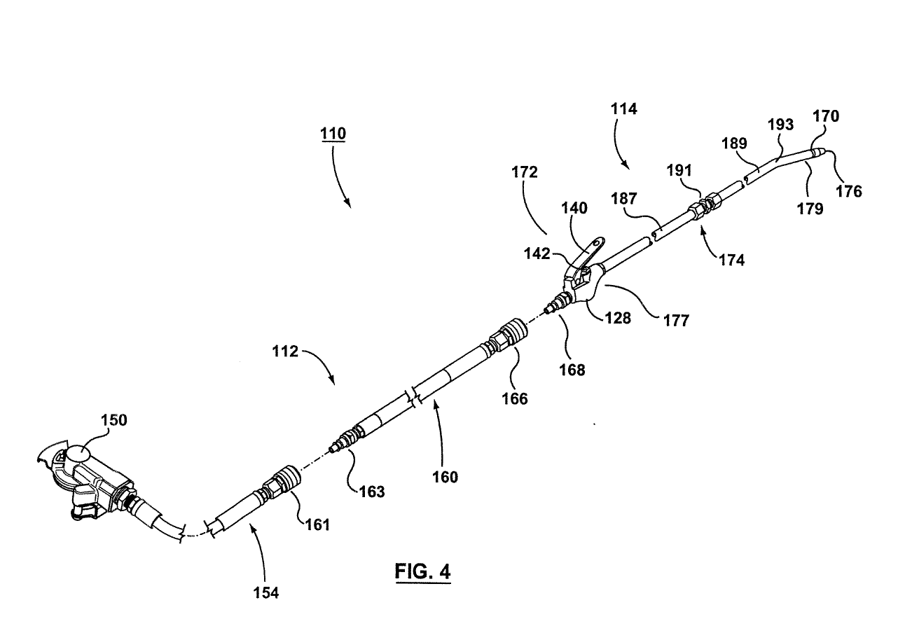

Referring now to FIG. 4, illustrated therein is a “dry” cleaning apparatus 110 made in accordance with a second embodiment of the present invention, adapted for cleaning floors that do not require application of liquid. Cleaning apparatus 110 comprises a compressed air supply hose 112 and a wand 114. Air supply hose 112 may be a two piece air hose comprising a short hose 154 and a long hose 160 that is releasably coupled thereto by couplers 161, 163. Short hose 154 has a brake line coupler 150 extending from one end thereof that is shaped for releasably coupling to a truck air brake system. Long hose 160 has a wand coupler 166 extending from one end for coupling to wand 114. Wand 114 comprises a tubular body 174 having an air passage extending therethrough, a handle portion 172 extending from a first end 177 of tubular body 174, a hose coupler 168 extending from handle portion 172 for coupling to wand coupler 166, and nozzle 176 extending from a second end 179.

Tubular body 174 of wand 114 may be a two piece tubular body comprising a first tubular body portion 187 and a second tubular body portion 189 releasably coupled thereto by a compression fitting 191. First tubular body portion 189 attaches to handle portion 172 at one end and attaches to compression fitting 191 at its opposing end. Second tubular body portion 189 attaches to compression fitting 191 at one end and attaches to nozzle 176 at its opposing end. Approximately 4 inches from the nozzle there is a bent portion 193 in second tubular body portion 189. Bent portion 193 extends at an angle relative to first tubular body portion 187 that is substantially the same as angle A of apparatus 10.

One benefit of providing a two-piece wand is that wand 114 can be shipped to an end user in a smaller package and stored in smaller storage compartments in truck 20. This becomes beneficial if the wand is greater than two feet long. However, shorter wands may not achieve the same benefit and it may be desirable to make the wand from a single piece. The two-piece wand construction may be applied to cleaning apparatus 10.

Handle portion 172 is of simpler construction than handle portion 72 of the first embodiment because there is no liquid mixer. Handle portion 172 comprises a lever 140 that sits on a poppet 142. Compressing lever 140 against handle 128 depresses the poppet 142, which allows a flow of air to proceed through wand 114 and exit out of nozzle 176. To control the airflow, a valve may be connected to poppet 142 in the same manner as needle valve 100. In an alternative embodiment, handle portion 172 may be replaced by handle portion 72 of the previous embodiment so as to convert cleaning apparatus 110 into a wet/dry cleaning apparatus like cleaning apparatus 10 such that a portable container may provide a flow of liquid to cleaning apparatus 110.

To facilitate airtight seals in either cleaning apparatus 10 or 110, some connectors may be brazed, welded, or covered with a sealing material. Some joints considered for this treatment include threaded fittings, valves and the nozzle.

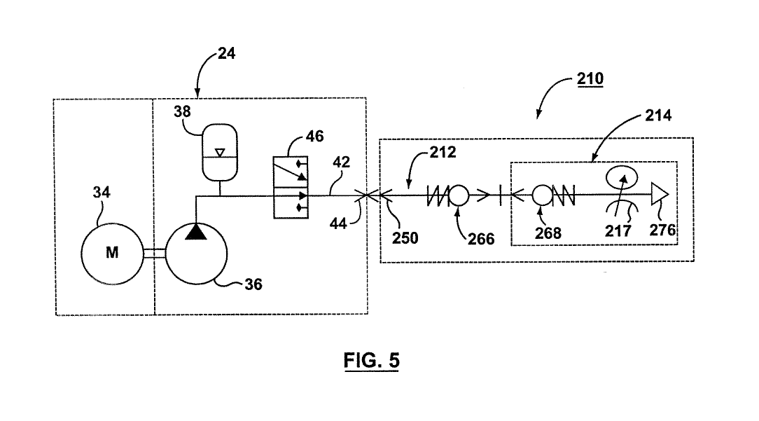

Referring now to FIG. 5, the present invention is also directed to a method for cleaning the interior of a trailer coupled to a transport truck using portable cleaning apparatus 210 made in accordance with another embodiment of the present invention. Cleaning apparatus 210 is adapted to be releasably coupled to truck air brake system 24 that comprises air compressor 36 powered by engine 34, air tank 38, trailer supply valve 46 that controls the airflow from air tank 38, trailer supply line 42, and trailer coupler 44 that is normally coupled to a trailer air brake system (not shown).

Cleaning apparatus 210 comprises a portable air supply hose 212 and a wand 214. Air supply hose 212 comprises a brake line coupler 250 extending from one end thereof that is shaped to be releasably coupled to trailer coupler 44. Extending from the opposing end of compressed air supply hose 212 is a wand coupler 266 that connects to a hose coupler 268 of wand 214. On the opposing free end of wand 214, a nozzle 276 directs airflow against an interior surface of trailer 20 such as corrugated floor 28. Wand 214 additionally comprises an airflow control 217 between second fitting 268 and nozzle 276.

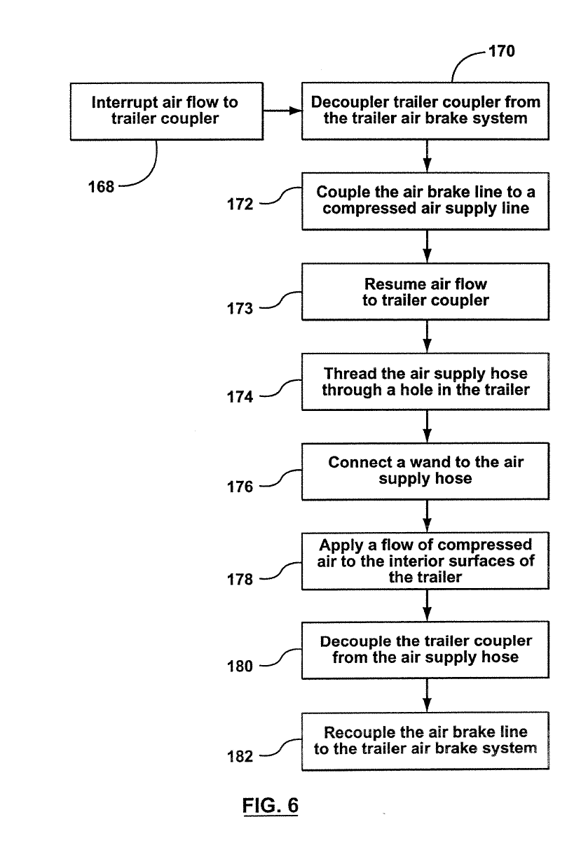

Referring now primarily to FIG. 6, depicting the steps of the method of the present invention, if engine 34 is running, the flow of compressed air to trailer supply line 42 (the red line) is interrupted at step 168 by closing trailer supply valve 46. Closing trailer supply valve 46 opens trailer supply line 42 to the atmosphere and releases any pressure within supply line 42 and trailer air brake system 24.

At step 170, trailer coupler 44 is decoupled from trailer air brake system 25. If using gladhand couplers, trailer coupler 44 is rotated 90° and is then removed from the corresponding coupler on trailer air brake system 25.

At step 172, cleaning apparatus 210 is coupled to truck air brake system 24 by connecting brake line coupler 250 of air supply hose 212 to trailer coupler 44. This creates an airflow passage between air compressor 36 and cleaning apparatus 210. If using gladhands, the two couplers are held on top of each other at 90° and they are then rotated 90° to a co-linear orientation that joins and locks the couplers together.

At step 173, the operator should ensure that trailer supply valve 46 is opened and that engine 34 is running at an rpm suitable to provide a continuous flow of compressed air to cleaning apparatus 210 from air compressor 36.

At step 174, a length of the air supply hose 212 is fed through aperture 30 in trailer 20. The operator then walks around trailer 20 carrying the rest of cleaning apparatus 210. Once inside the trailer 20, the operator may connect a second piece of the hose to the first piece, if cleaning apparatus 210 comprises a two piece hose such as that disclosed in FIG. 2 or FIG. 4. The second piece of the hose should have a length such that a user of cleaning apparatus 210 can reach all interior portions of trailer 20.

At step 176, wand 214 is connected to compressed air supply hose 212 by coupling wand coupler 266 to hose coupler 268. Preferably, couplers 266, 268 are quick-connect fittings having check valves that prevent the release of air to the external environment when they are not connected to each other. Alternatively, the couplers may be comprise other types of fittings suitable for connecting compressed air supply hose 212 to wand 214.

At step 178, the operator uses wand 214 and airflow control 217 to apply a flow of compressed air to interior surfaces of trailer 20. Airflow control 217 allows the user to control the flow of air when cleaning dirt from surfaces. When the user is not cleaning, the airflow may be completely restricted by airflow control 217.

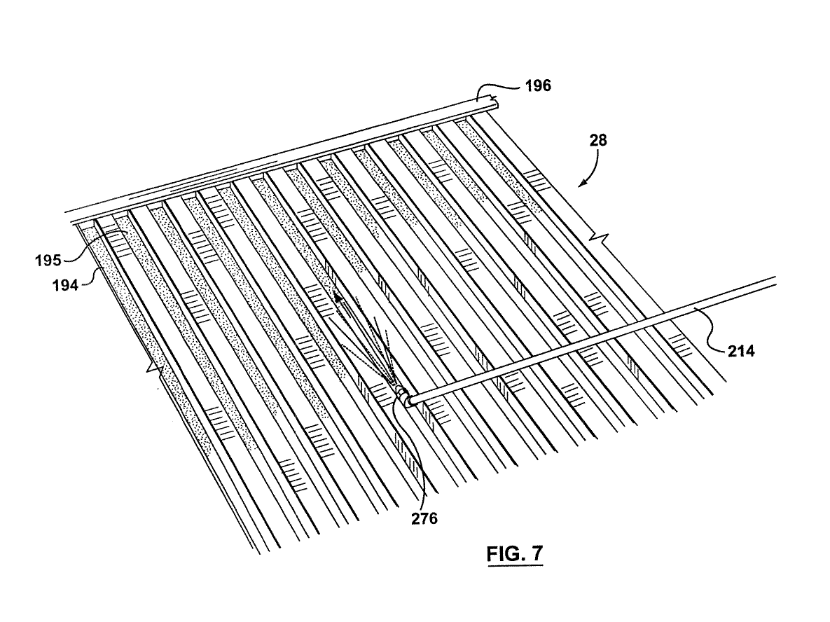

As shown in FIG. 7, the angle of nozzle 276 allows the operator to clean corrugated floor 28 from a comfortable standing position. This angle is also applied to nozzles 76, 176. The ergonomical angle itself should be determined based on the average height of a user and the length of the wand.

Applying a controlled flow of air to dirt within channels 194, 195 of corrugated floor 28 allows the operator to progressively push dirt to the end of trailer 20. At the end of trailer 20 there is usually a lip 196. Some dirt may be sprayed out and over lip 196 while other pieces of debris may need to be removed by manually picking them off corrugated floor 28.

In some embodiments where a liquid is introduced into the airflow, liquid droplets may frictionally clean muck or stains from surfaces. Preferably, the amount of liquid imparted to the flow is such that the liquid can remove dirt by friction dissolution, chemical decomposition or otherwise. However, the liquid should not be in excess, such that after cleaning is complete, a significant amount of dry time is required before loading items into trailer 20.

It is recommended that safety glasses, safety shoes, gloves and heavy clothing be worn while cleaning trailer 20 to prevent injury to the operator. Otherwise, when dirt is being sprayed, flying particles may injure the operator.

After cleaning is complete, the operator may, at step 180, decouple compressed air supply hose 212 from supply line 42. This step should begin by first closing trailer supply valve 46 to purge air from supply line 42. After purging both supply line 42 and cleaning apparatus 210, air line coupler 250 may be decoupled from trailer coupler 44. If gladhands are implemented, the couplers should be rotated to a 90° angle and then removed from each other.

At step 182, trailer coupler 44 is recoupled to trailer air brake system 25. After the connection is made, trailer supply valve 46 may be opened to allow normal operation of air brake systems 24, 25.

Although the cleaning apparatus of the present invention is adapted for cleaning the floor of a reefer trailer, it should be understood that the cleaning apparatus of the present invention could be used to clean the interior surfaces of other types of trailers. The method and apparatus of the present invention could also be used on other parts of the transport truck or even other surfaces detached from the transport truck.

It should therefore be apparent to one skilled in the art that various modifications can be made to the embodiment disclosed herein, without deviating from the present invention, the scope of which is defined in the appended claims.

1. An apparatus for cleaning an interior portion of a trailer coupled to a transport truck, the truck having an engine and an air brake system comprising an air compressor powered by the engine, and an air brake line connected to the air compressor, the air brake line having a trailer coupler for coupling the air brake line to a trailer brake system associated with the trailer, the apparatus comprising:
a) an air supply hose having a brake line coupler shaped to releasably couple to the trailer coupler so as to receive a flow of compressed air from the air compressor;
b) a wand releasably couplable to the air supply hose, the wand comprising a tubular body having a flow passage therethrough, a hose coupler extending from a first end of the tubular body for coupling to the air supply hose, a nozzle extending from a second end of the tubular body, a handle portion spaced from the second end, and a control for controlling the flow of compressed air to the nozzle; and
c) a liquid delivery system for delivering liquid to the air flow passage of the wand.

2. The apparatus defined in claim 1, wherein the air supply hose comprises a short air hose and a long air hose releasably coupled to the short hose, the short hose being sized to extend from the trailer coupler through an aperture in the trailer to a selected point inside a forward portion of the interior of the trailer, the long air hose being sized to extend from the selected point through the interior portion of the trailer.

3. The apparatus defined in claim 1, wherein the liquid delivery system comprises a portable container for holding a supply of liquid, a mixer for mixing the liquid into the flow of compressed air, and a liquid supply line extending from the container to the mixer.

4. The apparatus defined in claim 2, wherein the mixer comprises a venturi located within the handle portion of the wand, the venturi being operable to siphon liquid from the liquid supply line.

5. The apparatus defined in claim 2, wherein the long air hose is coupled to the short hose by a hose coupler, and wherein the hose coupler comprises a check valve that stops the flow of compressed air when the short air hose is decoupled from the long air hose.

6. The apparatus defined in claim 1, wherein the tubular body comprises a first tubular body portion and a second tubular body portion, the second tubular body portion being releasably couplable to the first tubular body portion.

7. The apparatus defined in claim 1, wherein the brake line coupler comprises a gladhand coupler.

8. The apparatus defined in claim 1, wherein the control is located in the handle portion of the wand.

9. An apparatus for cleaning an interior portion of a trailer coupled to a transport truck, the truck having an engine and an air brake system comprising an air compressor powered by the engine, and an air brake line connected to the air compressor, the air brake line having a trailer coupler for coupling the air brake line to a trailer brake system associated with the trailer, the apparatus comprising:
a) an air supply hose having a first end and a second end, a brake line coupler extending from the first end shaped for releasably coupling to the trailer coupler so as to receive a flow of compressed air from the air compressor, and a wand coupler extending from the second end;
b) a wand releasably couplable to the air supply hose, the wand comprising a tubular body having a tubular passage extending therethrough, a handle portion extending from a first end of the tubular body, a hose coupler extending from the handle portion for coupling the wand to the wand coupler, and a nozzle extending from a second end of the tubular body, the handle portion including a control for controlling the flow of compressed air to the nozzle;
c) wherein the air supply hose and the wand coupler are sized to fit through an aperture in a forward portion of the trailer.

10. The apparatus defined in claim 9, wherein the compressed air supply hose comprises a short hose and a long hose releasably coupled to the short hose, the short hose being sized to extend from the brake line coupler through the aperture in the trailer to a selected point inside a forward portion of the interior of the trailer, the long hose being sized to extend from the selected point through the interior of the trailer.

11. The apparatus defined in claim 9, wherein the tubular body comprises a first tubular body portion and a second tubular body portion, the second tubular body portion being releasably couplable to the first tubular body portion.

12. The apparatus defined in claim 9, wherein the liquid delivery system comprises a portable container for holding a supply of liquid, a mixer for mixing the liquid into the flow of compressed air, and a liquid supply line extending from the container to the mixer.

13. A method for cleaning an interior surface of a trailer coupled to a tractor, the trailer having an air brake system, the tractor having an engine and an air brake system comprising an air compressor powered by the engine for creating a flow of compressed air, an air brake line connected to the air compressor, the air brake line having a trailer coupler for coupling the air brake line to a trailer air brake system associated with the trailer, comprising the steps of:
a) decoupling the trailer coupler of the air brake line from the trailer air brake system;
b) coupling a portable air supply hose to the air brake line by coupling a brake line coupler extending from a first end of the air supply hose to the trailer coupler;
c) threading the air supply hose through an aperture in a forward portion of the trailer;
d) connecting a wand to the air supply hose, the wand having a nozzle at a free end and a control for controlling the flow of compressed air through the nozzle; and
e) using the wand and control to apply a controlled flow of compressed to the interior surface to clean the surface.

14. The method defined in claim 13, comprising the further steps of:
a) decoupling the trailer coupler from the air supply hose after cleaning the interior surface of the trailer; and
b) recoupling the trailer coupler to the trailer air brake system.

15. The method defined in claim 13, comprising the steps of interrupting the flow of compressed air to the trailer coupler prior to decoupling the trailer coupler, and resuming the flow of compressed air to the trailer coupler after coupling the air supply hose to the air brake line.
